(19) United States
(12) Patent Application Publication
(10) Pub. No.: US 2020/0385116 A1
(43) Pub. Date: Dec. 10, 2020

(54) System and Method of Operating a Vehicular Computing Device to Selectively Deploy a Tethered Vehicular Drone for Capturing Video

(71) Applicant: MOTOROLA SOLUTIONS, INC., CHICAGO, IL (US)

(72) Inventors: SHERVIN SABRIPOUR, PLANTATION, FL (US); CHI T. TRAN, NAPERVILLE, IL (US); DO HYUNG KIM, CHICAGO, IL (US)

(21) Appl. No.: 16/433,157

(22) Filed: Jun. 6, 2019

(51) Int. Cl. B64C 39/02; G08G 5/00; G06T 7/20

(52) U.S. Cl. CPC B64C 39/024; G08G 5/0069; B64C 2201/127; B64C 2201/148; G06T 7/20

(57) ABSTRACT

A vehicular computing device is operated to selectively deploy a tethered vehicular drone for capturing video. In operation, the vehicular computing device detects (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively deploys the tethered vehicular drone from a vehicular docked position to a tethered flight position to begin capturing video via a drone camera coupled to the tethered vehicular drone, and receives video captured via the drone camera while the tethered vehicular drone is deployed at the tethered flight position.

### BACKGROUND OF THE INVENTION

In-vehicle cameras are deployed in vehicles such as police cars for evidentiary and investigation purposes. Public safety officers often rely on videos recorded by in-vehicle cameras such as dashboard cameras to provide consistent documentation of their actions in case of critical events such as officer-involved shootings or to investigate allegations of police brutality or other crimes/criminal intent. However, videos captured by in-vehicle cameras are prone to be unstable or un-viewable due to external factors such as uneven road surfaces and abnormal weather conditions. Such poorly captured videos may not be admissible in courts and further it may not be useable for evidentiary or investigation purposes. Existing technologies allow for post processing of videos to improve the video quality. However, post processing of videos may conflict with evidentiary policies that enforce stricter chain-of-custody and tampering control requirements.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1A is a system diagram illustrating a vehicular camera system including a tethered vehicular drone that is deployed in a vehicular docked position in accordance with some embodiments.

FIG. 1B is a system diagram illustrating a vehicular camera system including a tethered vehicular drone that is deployed in a tethered flight position in accordance with some embodiments.

FIG. 2 is a device diagram showing a device structure of a vehicular computing device of the system of FIGS. 1A and 1B in accordance with some embodiments.

FIG. 3 illustrates a flow chart of a method of operating a vehicular computing device of FIGS. 1A and 1B to selectively deploy a tethered vehicular drone for capturing video in accordance with some embodiments.

FIG. 4A illustrates an example of image captured by a vehicular camera system while a tethered vehicular drone is deployed in a vehicular docked position.

FIG. 4B illustrates an example of image captured by a vehicular camera system while a tethered vehicular drone is deployed in a tethered flight position.

FIG. 5A illustrates an example of an object of interest being tracked by a vehicular camera system while the tethered vehicular drone is deployed in a vehicular docked position.

FIG. 5B illustrates an example of an object of interest being tracked by a vehicular camera system while the tethered vehicular drone is deployed in a tethered flight position.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One embodiment provides a method of operating a vehicular computing device to selectively deploy a tethered vehicular drone for capturing video, the method includes detecting (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively: deploying the tethered vehicular drone from a vehicular docked position to a tethered flight position to begin capturing video via a drone camera coupled to the tethered vehicular drone; and receiving video captured via the drone camera while the tethered vehicular drone is deployed at the tethered flight position.

Another embodiment provides a vehicular computing device including an electronic processor and a communication interface. The electronic processor is configured to: detect (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively: deploy a tethered vehicular drone from a vehicular docked position to a tethered flight position to begin capturing video via a drone camera coupled to the tethered vehicular drone; and receive, via the communication interface, video captured via the drone camera while the tethered vehicular drone is deployed at the tethered flight position.

A further embodiment provides a vehicular camera system including a vehicular computing device operating at a vehicle and a tethered vehicular including a drone camera. The vehicular computing device is coupled to a vehicular power source and a vehicular camera. The tethered vehicular drone is physically coupled to the vehicle via a tether cable. The vehicular computing device detects (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively: deploys the tethered vehicular drone from a vehicular docked position to a tethered flight position to begin capturing video via the drone camera; and receives, via the tether cable, video captured via the drone camera while the tethered vehicular drone is deployed at the tethered flight position.

Each of the above-mentioned embodiments will be discussed in more detail below, starting with example communication system and device architectures of the system in which the embodiments may be practiced, followed by an illustration of processing steps for achieving the method, device, and system described herein. Further advantages and features consistent with this disclosure will be set forth in the following detailed description, with reference to the figures.

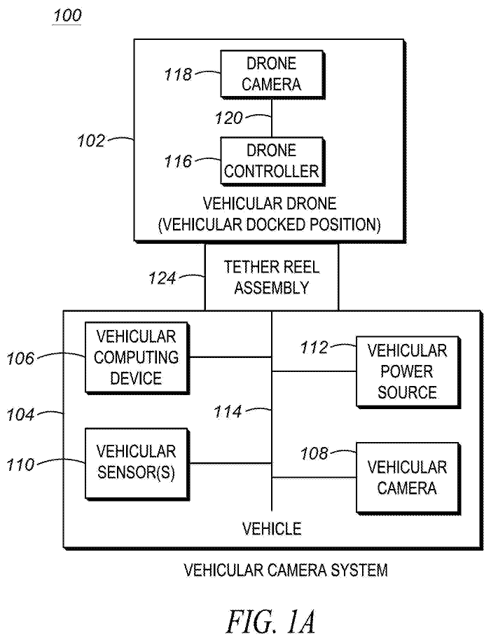

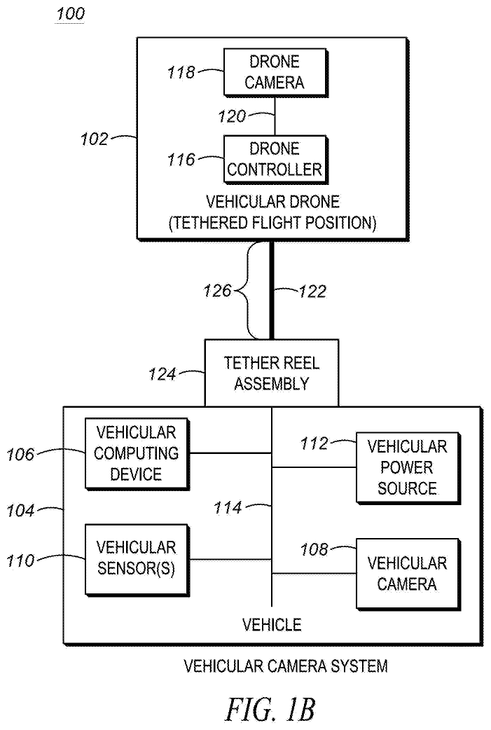

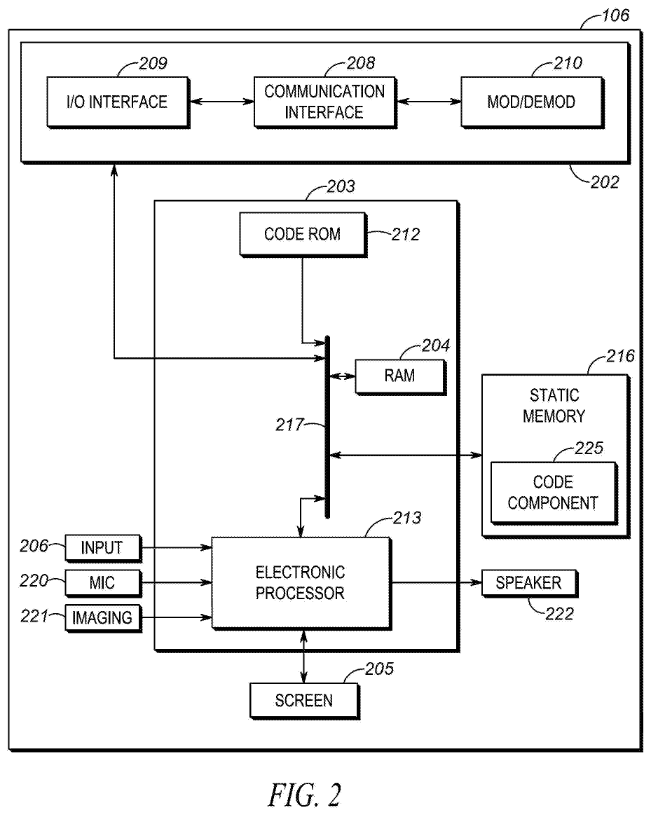

Referring now to the drawings, and in particular FIGS. 1A and 1B, a system diagram illustrates a vehicular camera system 100 including a vehicular drone 102 that is tethered to a vehicle 104 is shown. The vehicle 104 is equipped with a vehicular computing device 106 that is operated in accordance with the embodiments described herein to selectively deploy the vehicular drone 102 (also referred herein as “tethered vehicular drone”) in one of (i) a vehicular docked position as shown in FIG. 1A or (ii) a tethered flight position as shown in FIG. 1B, for capturing video. The vehicular computing device 106 may be any computing device specifically adapted for operation within the vehicle 104, and may include, for example, a vehicular console computing device, a tablet computing device, a laptop computing device, or some other computing device commensurate with the rest of this disclosure and may contain many or all of the same or similar features as set forth in FIG. 2. The vehicle 104 may be a human-operable vehicle, or may be partially or fully self-driving vehicle operable under control of the vehicular computing device 106. The vehicle 104 may be a land-based, water-based, or air-based vehicle. Examples of vehicles include a passenger or police car, a bus, a fire truck, an ambulance, a ship, an airplane, and the like.

The vehicle 104 is further equipped with a vehicular camera 108, one or more vehicular sensors 110, and a vehicular power source 112 that are communicatively coupled to the vehicular computing device 106 via a local interface 114. The local interface 114 may include one or more buses or other wired or wireless connections, controllers, buffers, drivers, repeaters, and receivers among many others to enable communications. The local interface 114 also communicatively couples the aforementioned components such as the vehicular computing device 106 and the vehicular power source 112 to the vehicular drone 102 (for example, via a tether reel assembly 124). Further, the local interface 114 may include address, control, power, and/or data connections to enable appropriate communications and/or power supply among the components of the vehicular camera system 100.

The vehicular camera 108 may include one or more in-vehicle cameras that may be mounted in (e.g., dashboard camera) and/or around (e.g., front, side, rear, or roof top cameras) the vehicle 104 on a suitable vehicular surface. In some embodiments, the vehicular camera 108 may provide visual data of the area corresponding to 360 degrees around the vehicle 104. The video (still or moving images) captured by the vehicular camera 108 may be recorded and further uploaded to a storage device that is implemented at one or more of the vehicular computing device 106, vehicular drone 102, an on-board vehicular storage component (not shown), or a remote cloud storage server (not shown). In accordance with some embodiments, the vehicular computing device 106 processes the video captured by the vehicular camera 108 and further computes a measure of the video quality of the video captured by the vehicular camera 108. When the measure of the video quality of the video captured by the vehicular camera 108 is not greater than a video quality threshold, the vehicular computing device 106 deploys the vehicular drone 102 from the vehicular docked position to the tethered flight position. In other embodiments, the vehicular computing device 106, in addition to or alternative to the measure of the video quality, uses vehicular metadata (e.g., vehicular motion dataset) obtained from one or more vehicular sensors 110 as a basis for determining whether the vehicular drone is to be deployed from the vehicular docked position shown in FIG. 1A to the tethered flight position shown in FIG. 1B.

The one or more vehicular sensors 110 include motion sensors that are configured to detect vehicular motion of the vehicle 104 and further generates motion dataset (indicating magnitude and direction of motion) associated with the vehicular motion. In one embodiment, one or more of the vehicular sensors 110 may be deployed at a site (e.g., an infrastructure device or server, or another vehicle) that is remotely located from the vehicle 104. The vehicular computing device 106 obtains the motion dataset to predict if the video quality is or will be affected (i.e., if the measure of video quality will drop below a video quality threshold) by vehicular motion and further determine if there is a need to deploy the vehicular drone 102 from the vehicular docked position to the tethered flight position. The motion sensor includes one or more of an accelerometer, a gyroscope, an optical sensor, infrared sensor, or ultrasonic wave sensor. The motion dataset may include real-time vehicular motion data such as speed of the vehicle 104, acceleration/deceleration of the vehicle 104, position of the vehicle 104, orientation of the vehicle 104, direction of movement of the vehicle 104, brake system status, steering wheel angle, vehicular vibration, and other operating parameters impacting the vehicular motion. In accordance with some embodiments, the vehicular computing device 106 measures a change in the vehicular motion (e.g., a magnitude of motion along one of x-axis, y axis, or z-axis direction) at a given point in time based on the motion dataset generated by the motion sensors. When the change in the vehicular motion is detected to be greater than a motion-change threshold, the vehicular computing device 106 deploys the vehicular drone 102 in a tethered flight position as shown in FIG. 1B.

The vehicular sensors 110 may be further configured to detect features (e.g., debris, dirt, water, mud, ice, bug etc.,) on a surface of the vehicle 104 (such as the windshield) that cause obstruction within a field-of-view of the vehicular camera 108. For example, the presence of ice or other contaminants on the vehicle's windshield may block the field-of-view of the vehicular camera 108 (such as a dashboard camera) to an object of interest and it is possible that video captured (or to be captured) by the vehicular camera 108 in such situations may not useable for evidentiary or investigation purposes. In accordance with embodiments, when the vehicular computing device 106 detects that there is an obstruction within a field-of-view of the vehicular camera 108 based on the data obtained from vehicular sensors 110, the vehicular computing device 106 deploys the vehicular drone 102 in a tethered flight position as shown in FIG. 1B.

The vehicular sensors 110 may further include vehicle environment sensors that may provide data related to the environment and/or location in which the vehicle 104 is operating (or will be operating), for example, road conditions (e.g., road bumps, potholes, etc.,), traffic, and weather. For example, the vehicular sensors 110 may also include one or more visible-light camera(s), infrared light camera(s), time-of-flight depth camera(s), radio wave emission and detection (such as radio direction and distancing (RADAR) or sound navigation and ranging (SONAR) device(s)), and/or light detection and ranging (LiDAR) devices that may capture road conditions such as road bumps and potholes, and other objects that may affect the video quality of the video captured by the vehicular camera 108. The vehicular sensors 110 may also include a vehicle location determination unit such as an on-board navigation system that utilizes global positioning system (GPS) technology to determine a location of the vehicle 104. In accordance with some embodiments, the vehicular computing device 106 may determine to deploy the vehicular drone 102 in a tethered flight position based on vehicle environment data such as road conditions. In addition, the vehicular computing device 106 may further use the data obtained from the vehicular sensors 110 to detect if an area of interest (e.g., an area behind the vehicle 104) or object of interest (e.g., an object being tracked is positioned above a top surface of the vehicle 104) to be recorded by the vehicular camera 108) is outside a field-of-view of the vehicular camera 108 and further responsively deploys the tethered vehicular drone 102 from the vehicular docked position to the tethered flight position when the data obtained from the vehicular sensors 110 indicates that the area of interest or object of interest is outside the field-of-view of the vehicular camera 108. In any case, the vehicular sensors 110 provide vehicular metadata to the vehicular computing device 106 to enable the vehicular computing device 106 to determine if there is a need to deploy the vehicular drone 102 from the vehicular docked position to the tethered flight position or vice versa.

The vehicular power source 112 such as a car battery supplies operating power to the vehicular computing device 106, the vehicular camera 108, and the one or more vehicular sensors 110. In accordance with some embodiments, the vehicular computing device 106, responsive to determining that the vehicular drone 102 is to be deployed from the vehicular docked position (as shown in FIG. 1) to the tethered flight position (as shown in FIG. 2), transmits a control signal to the vehicular power source 112 via the local interface 114 to start supplying operating power to the vehicular drone 102. In response to the control signal received from the vehicular computing device 106, the vehicular power source 112 begins supplying power to the vehicular drone 102 to enable the vehicular drone 102 to deploy from the vehicular docked position shown in FIG. 1A to the tethered flight position shown in FIG. 1B. In some embodiments, the vehicular power source 112 does not supply operating power to the vehicular drone 102 while the vehicular drone 102 is deployed in a vehicular docked position shown in FIG. 1A.

The vehicular drone 102 includes a drone camera 118 that is coupled to the drone controller 116 via a drone interface 120. The drone interface 120 may include elements that are same or similar to the local interface 114. The drone controller 116 may activate operation of the drone camera 118 for capturing video (still or moving images) by performing a procedure to deploy the vehicular drone from the vehicular docked position shown in FIG. 1A to the tethered flight position shown in FIG. 1B, in accordance with a control signal received from the vehicular computing device 106. In embodiments, the drone camera 118 does not begin capturing the video until the vehicular drone 102 is fully deployed to the tethered flight position as shown in FIG. 1B. In accordance with some embodiments, when the vehicular drone 102 is deployed to the vehicular docked position as shown in FIG. 1A, the vehicular camera 108 may be enabled to capture video while the drone camera 118 is disabled from capturing video.

The vehicular drone 102 is tethered to the vehicle 104 via a tether cable 122 (an exposed part of the tether cable 122 is schematically shown in FIG. 1B) that is housed in a tether reel assembly 124. In one embodiment, one end of the tether cable 122 may be coupled to a structure (e.g., bottom surface) of the vehicular drone 102 and other end of the tether cable 122 may be coupled to a structure (e.g., a top surface) of the vehicle 104. The tether reel assembly 124 may be a structure separate from the vehicular drone 102 and/or the vehicle 104, or alternatively the tether reel assembly 124 may be designed to be partially (or entirely) disposed within the structure of the vehicle 104 and/or within the structure of the vehicular drone 102.

In accordance with embodiments described herein, the vehicular computing device 106 determines a need to deploy the tethered vehicular drone from a vehicular docked position shown in FIG. 1A to a tethered flight position shown in FIG. 1B based on detecting one or more of: (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and further responsively deploys the tethered vehicular drone from a vehicular docked position to a tethered flight position to begin capturing video via the drone camera 118 coupled to the vehicular drone 102 and receives video captured via the drone camera 118 while the vehicular drone 102 is deployed at the tethered flight position.

The tether cable 122 is configured to carry control, data, and power signal between components of the vehicle 104 and components of the vehicular drone 102. In accordance with some embodiments, the vehicular power source 112 begins supplying power to the components (drone camera 118 and drone controller 116) of the vehicular drone 102 via the tether cable 122 in response to an instruction from the vehicular computing device 106 indicating that the vehicular drone 102 is to be deployed from the vehicular docked position to the tethered flight position. In one embodiment, the vehicular computing device 106 transmits a control signal to the drone controller 116 via the local interface 114 and tether cable 122 to deploy the vehicular drone 102 from the vehicular docked position to the tethered flight position. In one embodiment, the control signal transmitted to the drone controller 116 may include control data to enable the drone controller 116 to control the operations of the drone camera 118 based on the control data. The control data may include one or more of: (i) motion dataset associated with the vehicular motion of the vehicle, (ii) operating parameters of the vehicle 104, (iii) vehicle environment data, (iv) video quality of video captured by the vehicular camera, (v) an indication of area of interest or an object of interest to be captured by the drone, (vi) pan, tilt, or zoom function to be performed by the vehicular camera. For example, the drone controller 116 uses motion dataset such as speed and direction of the vehicle 104 to track exact movement of the vehicle 104 and further to properly position/align the vehicular drone 102 for video capturing while the vehicular drone 102 is being deployed in the tethered flight position. Additionally, or alternatively, the control signal may be transmitted to the tether reel assembly 124 to enable the tether reel assembly 124 to controllably release the tether cable 122 for deploying the vehicular drone to the tethered flight position. In accordance with some embodiments, the video recorded by the drone camera 118 while the vehicular drone is deployed to the tethered flight position is transmitted from the drone camera 118 to the vehicular computing device 106 via the tether cable 122.

In one embodiment, the vehicular computing device 106 determines a distance to be maintained between an end of the tether cable 122 connected to a surface of the vehicle 104 and other end of the tether cable 122 connected to a body of the vehicular drone 102 in order for the vehicular drone 102 to be deployed to the tethered flight position. In accordance with some embodiments, the distance to be maintained between the surface of the vehicle 104 and the body of the drone for proper flight positioning of the drone 102 may be determined as a function of the vehicular metadata such as motion dataset and/or vehicle environment data obtained from vehicular sensors 110, an area of interest or object of interest (e.g., relative direction/position of the area/object) relative to which the vehicular drone 102 needs to be positioned, and vehicle information (vehicle type, make, dimensions etc.). In other embodiments, the distance to be maintained between the surface of the vehicle 104 and the body of the vehicular drone 102 in order for the vehicular drone 102 to be deployed to the tethered flight position, may correspond to a user-defined distance. In one embodiment, the vehicular computing device 106 adjusts a length 126 of the tether cable 122 (see FIG. 1B) between the vehicular drone 102 and the vehicle 104 to match the distance (user-defined distance or determined distance) by controllably releasing the tether cable 122 from the tether reel assembly 124 in order for the vehicular drone 102 to be deployed from the vehicular docked position to the tethered flight position. For example, the length of the tether cable 122 that is exposed to maintain a distance between the vehicle 104 and vehicular drone 102 at the vehicular drone's tethered flight position may be four feet (4 ft.) while the length of the tether cable 122 that is exposed between the vehicle 104 and vehicular drone at the vehicular drone's vehicular drone position may be negligible (e.g., 0 ft.).

In one embodiment, the tether reel assembly 124 may be implemented to include a winch with a reel (not shown) for holding the tether cable 122, such that an end of the tether cable 122 is coupled to a body of the vehicular drone 102. The winch may be selectively controlled by the vehicular computing device 106 and/or the drone controller 116 to reel out/release the tether cable 122 to match a distance/angle to be maintained between the surface of the vehicle 104 and the body of the vehicular drone 102 in order to allow the tethered vehicular drone 102 to deploy from the vehicular docked position to the tethered flight position. Similarly, the winch may be selectively controlled by the vehicular computing device 106 and/or the drone controller 116 to reel in/retract the tether cable 122 when the vehicular drone is returned to the vehicular docked position. Other possible electrical and/or mechanical means for selectively controlling the tether cable 122 to deploy the vehicular drone 102 between the two positions, i.e., vehicular docked position and tethered flight position, exists as well.

Now referring to FIG. 2, a schematic diagram illustrates a vehicular computing device 106 of FIGS. 1A and 1B according to some embodiments of the present disclosure. Depending on the type of the device, the vehicular computing device 106 may include fewer or additional components in configurations different from that illustrated in FIG. 2. As shown in FIG. 2, the vehicular computing device 106 includes a communications unit 202 coupled to a common data and address bus 217 of a processing unit 203. The vehicular computing device 106 may also include one or more input devices (for example, keypad, pointing device, touch-sensitive surface, button, a microphone 220, an imaging device 221, and/or a user input interface device 206) and an electronic display screen 205 (which, in some embodiments, may be a touch screen and thus also acts as an input device), each coupled to be in communication with the processing unit 203. In one embodiment, the user input interface device may allow a user to provide user input identifying a user-defined distance to be maintained between the vehicular drone and the vehicle 104 when the vehicular drone is to be deployed from a vehicular docked position shown in FIG. 1A to a tethered flight position shown in FIG. 1B.

The microphone 220 may be present for capturing audio from a user and/or other environmental or background audio that is further processed by processing unit 203 and/or is transmitted as voice or audio stream data, or as acoustical environment indications, by communications unit 202 to other devices. The imaging device 221 may provide video (still or moving images) of an area in a field-of-view for further processing by the processing unit 203 and/or for further transmission by the communications unit 202. In one embodiment, the imaging device 221 may be alternatively or additionally used as a vehicular camera (similar to vehicular camera 108 shown in FIGS. 1A and 1B) for capturing videos. A speaker 222 may be present for reproducing audio that is decoded from voice or audio streams of calls received via the communications unit 202 from other devices, from digital audio stored at the vehicular computing device 106, from other ad-hoc or direct mode devices, and/or from an infrastructure RAN device, or may playback alert tones or other types of pre-recorded audio. In one embodiment, the speaker 222 may provide an audio prompt to the user of the vehicle 104 to indicate that the vehicular drone is being deployed from the vehicular docked position as shown in FIG. 1A to the tethered flight position as shown in FIG. 1B.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other devices, over which incoming calls may be received and over which communications with remote databases and/or servers may occur. In one embodiment, the video captured by the vehicular camera 108 and/or the drone camera 118 may be transmitted to a remote database and/or a server via the communications unit 202. For example, the communications unit 202 may include a communication interface 208 that may include one or more wireless transceivers, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communication interface 208 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The communication interface 208 is also coupled to a combined modulator/demodulator 210.

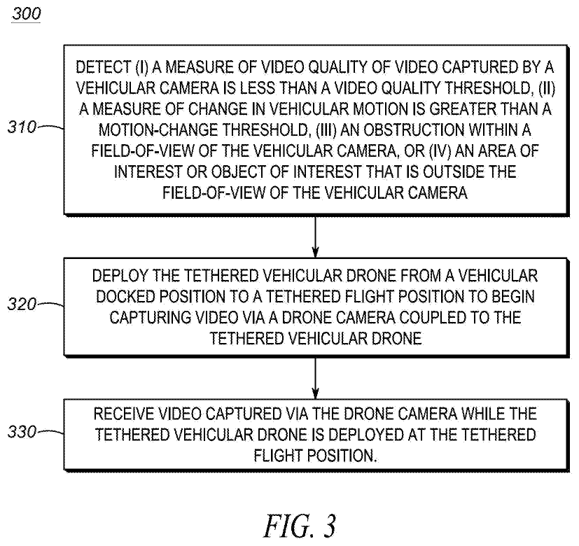

The electronic processor 213 has ports for coupling to the display screen 205, the microphone 220, the imaging device 221, the user input interface device 206, and/or the speaker 222. Static memory 216 may store operating code 225 for the electronic processor 213 that, when executed, performs the functionality of selectively deploying the vehicular drone for capturing video as shown in one or more of the blocks set forth in FIG. 3 and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like. The static memory 216 may store the video captured by the vehicular camera 108 and/or the drone camera 118.

In examples set forth herein, the vehicular computing device 106 is not a generic computing device, but a device specifically configured to implement functionality of selectively deploying a tethered vehicular drone for capturing video. For example, in some embodiments, the vehicular computing device 106 specifically comprises a computer executable engine configured to implement functionality of selectively deploying a tethered vehicular drone for capturing video.

Turning now to FIG. 3, a flowchart diagram in FIG. 3 illustrates a process 300 for selectively deploying a tethered vehicular drone for capturing video. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. An electronic computing device, such as the vehicular computing device 106 of FIGS. 1-2 embodied as a singular computing device or distributed computing device as set forth earlier, may execute process 300.

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well.

During normal operation of the vehicle 104, the vehicular drone 102 is deployed in a vehicular docked position as shown in FIG. 1A. While the vehicular drone 102 is deployed in the vehicular docked position, the vehicular camera 108 is enabled to capture video. In accordance with some embodiments, the drone camera 118 is disabled from capturing video while the vehicular drone 102 is deployed at the vehicular docked position. In any case, the vehicular computing device 106 continues to receive and process video that is captured by the vehicular camera 108 while the vehicular drone 102 is deployed at the vehicular docked position. In accordance with some embodiments, the vehicular computing device 106 continues to process video captured by the vehicular camera and vehicular metadata (e.g., motion dataset) obtained from vehicular sensors 110 to determine if there is a need to deploy the vehicular drone 102 from the vehicular docked position to the tethered flight position for capturing video via the vehicular drone 102.

As shown in block 310, the vehicular computing device 106 determines that there is a need to deploy the vehicular drone 102 from the vehicular docked position to tethered flight position when the vehicular computing device 106 detects one or more of: (i) a measure of video quality of video captured by a vehicular camera is less than a video quality threshold, (ii) a measure of change in vehicular motion is greater than a motion-change threshold, (iii) an obstruction within a field-of-view of the vehicular camera 108, or (iv) an area of interest or object of interest that is outside the field-of-view of the vehicular camera 108.

In one embodiment, the vehicular computing device 106 computes a measure of video quality by processing, in real-time, the video captured by the vehicular camera 108. For example, the vehicular computing device 106 computes a measure of the video quality based on analysis of one or more video features that are extracted from the video captured by the vehicular camera 108. The video features that are analyzed include, but not limited to: camera motion, bad exposure, frame sharpness, out-of-focus detection, brightness (e.g., due to lens flare), overexposure on certain regions of captured image, illumination, noisy frame detection, color temperature, shaking and rotation, blur, edge, scene composition, and detection of other vehicular metadata obtained, for example, from vehicular sensors 110. In any case, the vehicular computing device 106 computes a measure of video quality based on the combination of one or more analyzed video features. In one embodiment, the video features extracted from the captured video can be quantized and normalized to compute a measure of the video quality with a range of values, for example, between ‘0’ and ‘10’, where the value of ‘0’ indicates a low video quality and the value of ‘10’ indicates a high video quality. In some embodiments, the vehicular computing device 106 may compute a measure of the video quality as a function of the video features extracted from the captured video and further as a function of vehicular metadata (e.g., motion dataset, vehicle environment data etc.,) obtained from vehicular sensors 110. The vehicular computing device 106 compares the computed measure of video quality with a video quality threshold. The video quality threshold may be a system-defined value or a user-defined value that is determined based on similar video features extracted from video captured by the vehicular camera when the vehicle 104 was operating under acceptable conditions. For example, acceptable conditions may correspond to a period during which the vehicle 104 was operating on a smooth road surface (e.g., a road surface without any potholes or bumps). For example, the video quality threshold may be set to a value of 8, and any measure of video quality (corresponding to the video captured by the vehicular camera 108) that is less than the threshold value of ‘8’ may cause the vehicular computing device 106 to generate a trigger (e.g., a control signal to drone controller 116) to deploy the vehicular drone 102 from the vehicular docked position to the tethered flight position. On the other hand, if it is determined that the measure of video quality is greater than the video quality threshold, the vehicular computing device 106 maintains the vehicular drone 102 at the vehicular docked position and further continues to capture video using the vehicular camera 108.

In accordance with some embodiments, the vehicular computing device 106, in addition to or alternative to computing a measure of the video quality of video captured by vehicular camera 108, computes a measure of change in vehicular motion. The vehicular computing device 106 may compute a measure of change in vehicular motion based on the motion dataset generated by the vehicular sensors 110. For example, the vehicular sensors 110 can provide information over time, e.g., periodically, such that past and present motion dataset can be compared to determined changes in the vehicular motion. In one embodiment, the motion dataset obtained from the vehicular sensors 110 can be quantized and normalized to compute a measure of change in the vehicular motion with a range of values, for example, between ‘0’ and ‘10’, where the value of ‘0’ indicates that there is no change in vehicular motion and the value of ‘10’ indicates an abrupt change in vehicular motion. Next, the vehicular computing device 106 compares the measure of change in the vehicular motion with a motion-change threshold. The motion-change threshold may be a system-defined value or a user-defined value that is determined based on motion dataset obtained from vehicular sensors 110 when the vehicle 104 was operating under acceptable conditions. For example, acceptable conditions may correspond to a period during which the vehicle 104 was operating on a smooth road surface (e.g., a road surface without any potholes or bumps). For example, the motion-change threshold may be set to a value of 5, and any measure of change in the vehicular motion (corresponding to the video captured by the vehicular camera 108) that is greater than the motion-change threshold of ‘5’ may cause the vehicular computing device 106 to generate a trigger to deploy the vehicular drone 102 from the vehicular docked position to the tethered flight position. On the other hand, if it is determined that the measure of change in the vehicular motion is not greater than the motion-change threshold, the vehicular computing device 106 maintains the vehicular drone 102 at the vehicular docked position and further continues to capture video using the vehicular camera 108.

In some embodiments, the measure of change in vehicular motion includes a predicted measure of change in vehicular motion. The predicted measure of change in vehicular motion may be determined based on the environment and/or location in which the vehicle 104 is operating. For example, the vehicular computing device 106 may determine, via the vehicle's 104 navigation system, that the vehicle 104 is expected to take a right-turn to a street which is associated with an uneven road surface (e.g., potholes, road bumps etc.,). In this case, the vehicular computing device 106 may calculate a predicted measure of change in the vehicular motion based on the dimensions of the potholes/road bumps or alternatively based on historical measure of change in vehicular motion on the same or similar road surface. In these embodiments, the vehicular computing device 106 may generate a trigger to deploy the vehicular drone from the vehicular docked position to the tethered flight position even before (for example, equivalent to 200 meters or 20 seconds) the vehicle 104 comes into contact with the features of the road surface that may cause a measure of change in the vehicular motion to be greater than the motion-change threshold.

In accordance with some embodiments, the vehicular computing device 106, in addition to or alternative to computing a measure of the video quality of video captured by vehicular camera 108 or computing a measure of change in vehicular motion, determines whether there is an obstruction within a field-of-view of the vehicular camera 108. In one embodiments, the obstruction within a field-of-view of the vehicular camera 108 is determined based on information obtained from vehicular sensors 110. For example, if the vehicular camera 108 is implemented as a dashboard camera and further if the data obtained from the vehicular sensors 110 indicates the presence of features such as dirt, debris, ice, water, or other contaminants or objects on a windshield surface, or the presence of an obstacle (e.g., tree, pillar, or a moving object such as another vehicle) between the vehicular camera 108 and an object of interest to be captured, then the vehicular computing device 106 may detect that there is an obstruction (e.g., partial or full obstruction of direct line of sight to object of interest) within a field-of-view of the vehicular camera 108. In this case, the vehicular computing device 106 may generate a trigger to deploy the vehicular drone 102 from the vehicular docked position to the tethered flight position.

In accordance with some embodiments, the vehicular computing device 106, in addition to or alternative to computing a measure of the video quality of video captured by vehicular camera 108 or computing a measure of change in vehicular motion or detecting a state of an obstruction within a field-of-view of the vehicular camera 108, determines whether there is an area of interest or object of interest that is outside the field-of-view of the vehicular camera 108. In these embodiments the vehicular computing device 106 may receive a request (e.g., user input) to capture video corresponding to a particular area of interest or an object of interest relative to the position of the vehicle 104. In response to receiving this request, the vehicular computing device 106 determines whether the vehicular camera 108 has a field-of-view of the selected area of interest. If it is determined that the vehicular camera 108 has a field-of-view of the selected area or object of interest, the vehicular computing device 106 maintains the vehicular drone 102 at the vehicular docked position shown in FIG. 1A and further captures video corresponding to the area of interest or object of interest using the vehicular camera 108. On the other hand, if it is determined that the vehicular camera's 108 field-of-view is outside of the selected area or object of interest, the vehicular computing device 116 generates a trigger to deploy the vehicular drone 102 from the vehicular docked position to the tethered flight position. As an example, the vehicular computing device 106 may receive an indication that an object of interest (e.g., a suspect car) is closely following the vehicle 104. In this case, if is determined that the vehicular camera 108 (e.g., a front camera such as a dashboard camera) does not have a field-of-view of an area behind the vehicle 104, the vehicular computing device 106 may generate a trigger to deploy the vehicular drone 102 from the vehicular docked position to the tethered flight position.

At block 320, the vehicular computing device 106 deploys the vehicular drone 102 from a vehicular docked position to a tethered flight position to begin capturing video via the drone camera 118 coupled to the vehicular drone 102. In one embodiment, the vehicular computing device 106 generates and transmits a first control signal with an instruction to the vehicular power source 112 to begin supplying power to the vehicular drone 102 via the tether cable 122. The vehicular computing device 106 then generates and transmits a second control signal to drone controller 116 via the powered tether cable 122 with an instruction to perform a procedure to deploy the vehicular drone 102 from the vehicular docked position to the tethered flight position. The second control signal may include information such as i) motion dataset (e.g., speed, acceleration) associated with the vehicular motion of the vehicle 104, (ii) operating parameters of the vehicle 104, (iii) vehicle environment data, (iv) video quality of video captured by the vehicular camera 108, (v) an indication of an area of interest or object of interest including speed, position, spatial orientation, and direction of the object of the interest to be captured by the vehicular drone 102, (vi) pan, tilt, or zoom function to be performed by the drone camera 118. The information included in the control signal enables the drone controller 116 to adjust one or more operating parameters (e.g., flight parameters such as speed and direction of the vehicular drone 102) of the vehicular drone 102 based on the control signal prior to capturing video via the drone camera 118. In one embodiment, the drone controller 116 adjusts a length of the tether cable 122 that is exposed between the tethered vehicular drone 102 and the vehicle 104 by controllably releasing the tether cable 122 from the tether reel assembly 124 as a function of motion dataset associated with the vehicular motion. In accordance with some embodiments, the drone controller 116 may deploy the vehicular drone 102 to the tethered flight position such that the vehicular drone 102 may be launched in a direction (e.g., by controllably releasing the tether cable 122 from the tether reel assembly 124 and/or adjusting the flight speed and direction of the vehicular drone 102) in which an object of interest to be captured is located relative to the vehicle 104. In one embodiment, the flight speed and direction of the vehicular drone 102 may be adjusted based on the speed of the movement of the object of interest. The object of interest could be located in any position (e.g., in any of the quadrants in a 360-degree camera coverage) surrounding the vehicle 104.

As described with reference to FIGS. 1A and 1B, the vehicular computing device 106 computes a proper distance to be maintained between the surface of the vehicle 104 and the body of the vehicular drone 102 as a function of the motion dataset and/or vehicle environment data obtained from vehicular sensors 110, an area of interest or object of interest (e.g., direction, height, width, etc.,) relative to which the vehicular drone 102 needs to be positioned, and vehicle information (vehicle type, make, dimensions etc.). Then the vehicular computing device 106 adjusts a length of the tether cable 122 that is exposed (see FIG. 1B) between the vehicular drone 102 and the vehicle 104 to match the distance (user-defined distance or determined distance) by controllably releasing the tether cable 122 from the tether reel assembly 124 in order for the vehicular drone 102 to be deployed from the vehicular docked position to the tethered flight position. In accordance with some embodiments, the drone controller 116 activates the drone camera 118 to begin capturing the video via the drone camera 118 after the tether cable 122 has been adjusted for proper alignment and position (and further after the operating parameters such as flight parameters of the vehicular drone 102 has been adjusted), thereby completing the deployment of the vehicular drone 102 at the tethered flight position. Adjusting the length of the tether cable 122 and operating parameters of the vehicular drone 102 as a function of motion dataset allows the drone camera 118 to be properly aligned and positioned (for example, to compensate for the vehicular motion) for image stabilization during capturing of video via the drone camera 118. Additionally, or alternatively, the second control signal may be transmitted to the tether reel assembly 124 to enable the tether reel assembly 124 to release the tether cable 122 for deploying the vehicular drone 102 to the tethered flight position. In accordance with some embodiments, the drone controller 116 controls the flight parameters of the vehicular drone 102 such that any obstacle (e.g., obstacle detected between the vehicular drone 102 and the object of interest) during the flight is automatically avoided by the vehicular drone 102 while the video (e.g., corresponding to the object of interest) is being captured by the drone camera 118.

Next, at block 330, the vehicular computing device 106 receives video captured via the drone camera 118 while the tethered vehicular drone 102 is deployed at the tethered flight position. In accordance with some embodiments, the vehicular computing device 106 receives video from the vehicular drone 102 via the tether cable 122. In another embodiment, when the vehicular drone 102 is equipped with wireless communication interface (e.g., short range transmitter), the vehicular computing device 106 may receive video from the vehicular drone 102 via a wireless communication link, such as Bluetooth, near field communication (NFC), Infrared Data Association (IrDA), ZigBee, and/or Wi-Fi,

In accordance with some embodiments, the vehicular computing device 106 continues to receive and process video captured by the vehicular camera 108 and vehicular metadata obtained from the vehicular sensors 110 while the video is being captured by the drone camera 118 in the tethered flight position. In these embodiments, the vehicular computing device 106 monitors one or more of: (i) a second measure of video quality corresponding to video captured by the vehicular camera 108, (ii) a second measure of change in vehicular motion, (iii) a state of the obstruction within the field-of-view of the vehicular camera 108, or (iv) a relative positioning of the area of interest or object of interest to the field-of-view of the vehicular camera 108. Further, when the vehicular computing device 106 detects (i) the second measure of video quality corresponding to video captured by the vehicular camera 108 is greater than the video quality threshold, (ii) the second measure of change in vehicular motion captured from the motion sensor is not greater than the motion-change threshold, (iii) the field-of-view of the vehicular camera 108 is not obstructed, and (iv) the area of interest or object of interest is within the field-of-view of the vehicular camera 108 the vehicular computing device 106 generates a trigger to deploy the vehicular drone 102 from the tethered flight position shown in FIG. 1B to the vehicular docked position shown in FIG. 1A. For example, the vehicular computing device 106 generates and transmits a control signal to the drone controller 116 and/or tether reel assembly 124 with an instruction to perform a procedure to deploy the vehicular drone 102 from the tethered flight position to the vehicular docked position. In response, the drone controller 116 and/or tether reel assembly 124 deploys the vehicular drone 102 at the tethered flight position, for example, by completely reeling in/retracting the tether cable 122. The drone controller 116 may further terminate capturing video via the drone camera 118 and transmit the video captured by the drone camera 118 to the vehicular computing device 106 prior to the vehicular drone 102 being deployed to the vehicular docked position. In these embodiments, the vehicular computing device 106 may detect that the vehicular drone 102 has been deployed at the vehicular docked position and further may transmit a control signal to the vehicular power source 112 with an instruction to stop supplying operating power to the vehicular drone 102. Accordingly, the process 300 may be repeated to deploy the vehicular drone 102 between the two positions, i.e., vehicular docked position and tethered flight position.

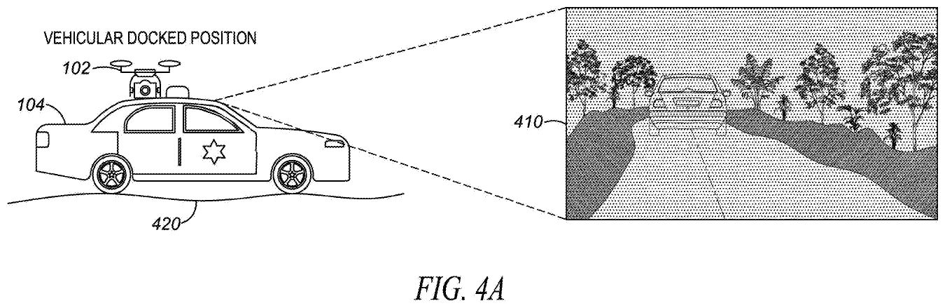

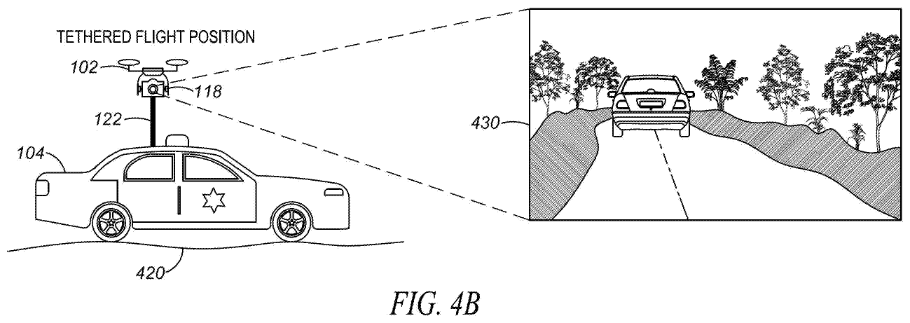

Now referring to FIG. 4A, a tethered vehicular drone 102 is shown as being deployed at a vehicular docked position. In the vehicular docked position, a vehicular camera 108 (not shown) at the vehicle 104 is enabled to capture a video 410. As shown in FIG. 4A, the video 410 captured by the vehicular camera 108 may be blurred because the vehicle 104 is shown as operating on an uneven road surface 420. In accordance with embodiments described herein, the vehicular computing device 106 computes a measure of the video quality of video 410 captured by the vehicular camera 108. In addition to or alternative to computing a measure of the video quality, the vehicular computing device 106 may also measure a change in the vehicular motion, for example, caused by the uneven road surface 420. In this case, when the measure of the video quality is less than a video quality threshold and/or when the change in the vehicular motion is greater than a motion-change threshold, the vehicular computing device 106 deploys the vehicular drone 102 from the vehicular docked position shown in FIG. 4A to a tethered flight position shown in FIG. 4B.

As shown in FIG. 4B, the vehicular drone 102 is deployed in a tethered flight position via the tether cable 122. In the tethered flight position, the drone camera 118 is activated to capture video 430. For example, the adjustment of the operating parameters such as flight parameters (e.g., speed and direction) of the vehicular drone 102 and the adjustment of the tether cable 122 ensures that the vehicular drone 102 remains stable and is further properly aligned and positioned at the tethered flight position to capture high quality video 430 (i.e., a measure of the video quality of video 430 is greater than the video quality threshold) while the vehicle 104 is operating in the uneven road surface 420.

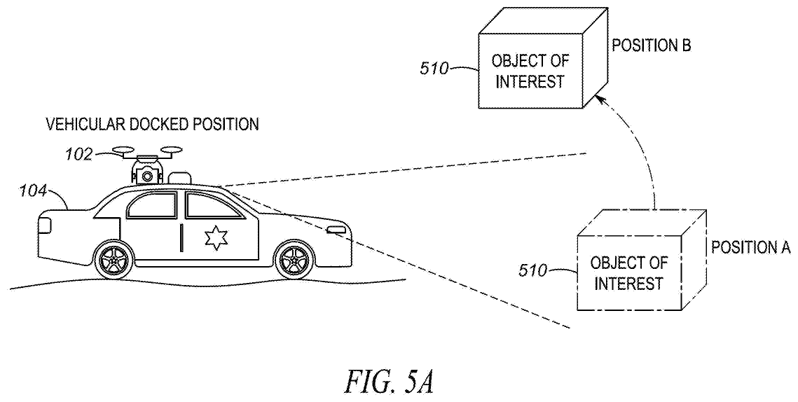

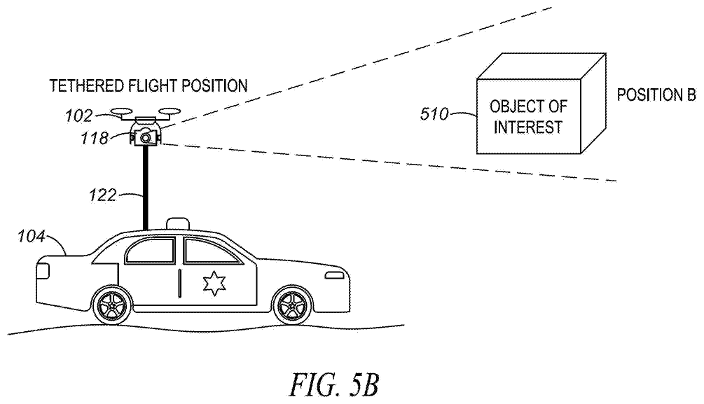

Now referring to FIG. 5A, a tethered vehicular drone 102 is shown as being deployed at a vehicular docked position. In the vehicular docked position, a vehicular camera 108 (not shown) at the vehicle 104 is enabled to capture a video. As shown in FIG. 5A, an object of interest 510 (e.g., a suspect) to be tracked is initially (say, at position A) positioned within a field-of-view of the vehicular camera 108. Further, as shown in FIG. 5A, the object of interest 510 has changed its position (e.g., from position A to position B) relative to the field-of-view of the vehicular camera 108. In this case, the vehicular computing device 106 detects that the object of interest 510 at position B is outside a field-of-view of the vehicular camera 108 and further sends a control signal to the vehicular drone 102 to deploy from the vehicular docked position shown in FIG. 5A to a tethered flight position shown in FIG. 5B. The control signal may identify, for example, a position and/or direction of movement of the object of interest 510 relative to the vehicle 104.

As shown in FIG. 5B, the vehicular drone 102 is deployed in a tethered flight position via the tether cable 122. In the tethered flight position, the drone camera 118 is activated and further relatively aligned and positioned based on the information included in the control signal (i.e., the position and/or direction of movement of the object of interest) in order to capture video corresponding to the object of interest 510.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of operating a vehicular computing device to selectively deploy a tethered vehicular drone for capturing video, the method comprising:
detecting (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively:
deploying the tethered vehicular drone from a vehicular docked position to a tethered flight position to begin capturing video via a drone camera coupled to the tethered vehicular drone; and
receiving video captured via the drone camera while the tethered vehicular drone is deployed at the tethered flight position.

2. The method of claim 1, wherein the tethered vehicular drone is tethered to a vehicle via a tether cable that is housed in a tether reel assembly coupled to the vehicle.

3. The method of claim 2, wherein deploying comprises:
causing a vehicular power source to supply operating power to the tethered vehicular drone via the tether cable.

4. The method of claim 2, wherein deploying comprises:
transmitting, via the tether cable, a control signal to the tethered vehicular drone to enable the tethered vehicular drone to adjust one or more operating parameters of the tethered vehicular drone based on the control signal prior to capturing video via the drone camera.

5. The method of claim 4, wherein the control signal includes information related to:
vehicular metadata including motion dataset associated with the vehicular motion,
pan, tilt, or zoom function to be performed by the drone camera, or
an indication of the area of interest or the object of interest corresponding to which the video is to be captured by the drone camera.

6. The method of claim 5, wherein the motion dataset identifies information related to related to vehicular speed, vehicular direction, vehicular acceleration or deceleration, vehicular orientation, vehicular location, or vehicular vibration.

7. The method of claim 2, wherein deploying comprises:
adjusting a length of the tether cable that is exposed between the tethered vehicular drone and the vehicle by controllably releasing the tether cable from the tether reel assembly as a function of motion dataset associated with the vehicular motion.

8. The method of claim 7, wherein the length of the tether cable between the tethered vehicular drone and the vehicle while the tethered vehicular drone is deployed at the tethered flight position is greater than a length of the tether cable between the tethered vehicular drone and the vehicle while the tethered vehicular drone is deployed at the vehicular docked position.

9. The method of claim 2, wherein receiving comprises:
receiving, via the tether cable, at the vehicular computing device, video captured by the drone camera.

10. The method of claim 1, further comprising:
responsive to deploying the tethered vehicular drone at the tethered flight position, continuing to receive and process video captured by the vehicular camera.

11. The method of claim 10, further comprising:
monitoring (i) a second measure of video quality corresponding to video captured by the vehicular camera, (ii) a second measure of change in vehicular motion, (iii) a state of the obstruction within the field-of-view of the vehicular camera, and (iv) a relative positioning of the area of interest or object of interest to the field-of-view of the vehicular camera.

12. The method of claim 11, further comprising:
responsive to monitoring, detecting (i) the second measure of video quality corresponding to video captured by the vehicular camera is greater than the video quality threshold, (ii) the second measure of change in vehicular motion is less than the motion-change threshold, (iii) the field-of-view of the vehicular camera is not obstructed, and (iv) the area of interest or object of interest is within the field-of-view of the vehicular camera, and responsively:
deploying the tethered vehicular drone from the tethered flight position to the vehicular docked position to terminate capturing video via the drone camera.

13. The method of claim 1, wherein the vehicular motion is captured via one or more motion sensors including an accelerometer, a gyroscope, optical sensor, infrared sensor, or ultrasonic wave sensor.

14. The method of claim 1, wherein the measure of change in vehicular motion includes (i) a computed measure of vehicular motion captured by a motion sensor physically coupled to a vehicle, or (ii) a predicted measure of change in vehicular motion based on vehicle environment data.

15. A vehicular computing device, comprising:
an electronic processor; and
a communication interface,
wherein the electronic processor is configured to:
detect (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively:
deploy a tethered vehicular drone from a vehicular docked position to a tethered flight position to begin capturing video via a drone camera coupled to the tethered vehicular drone; and
receive, via the communication interface, video captured via the drone camera while the tethered vehicular drone is deployed at the tethered flight position.

16. The vehicular computing device of claim 15, wherein the tethered vehicular drone is tethered to a vehicle via a tether cable that is housed in a tether reel assembly coupled to the vehicle, wherein the electronic processor is configured to cause a vehicular power source to supply operating power to the tethered vehicular drone via the tether cable when the tethered vehicular drone is being deployed from the vehicular docked position to the tethered flight position.

17. The vehicular computing device of claim 16, wherein the electronic processor is configured to:
transmit, via the tether cable, a control signal to the tethered vehicular drone to enable the tethered vehicular drone to adjust one or more operating parameters of the tethered vehicular drone based on the control signal prior to capturing video via the drone camera.

18. The vehicular computing device of claim 16, wherein the electronic processor is configured to:
adjust a length of the tether cable that is exposed between the tethered vehicular drone and the vehicle by controllably releasing the tether cable from the tether reel assembly as a function of motion dataset associated with the vehicular motion.

19. A vehicular camera system, comprising:
a vehicular computing device operating at a vehicle, the vehicular computing device coupled to a vehicular power source and a vehicular camera; and
a tethered vehicular drone including a drone camera, the tethered vehicular drone physically coupled to the vehicle via a tether cable, wherein the vehicular computing device detects (i) a measure of video quality of video captured by a vehicular camera is less than a video quality threshold, (ii) a measure of change in vehicular motion is greater than a motion-change threshold, (iii) an obstruction within a field-of-view of the vehicular camera, or (iv) an area of interest or object of interest that is outside the field-of-view of the vehicular camera, and responsively:
deploys the tethered vehicular drone from a vehicular docked position to a tethered flight position to begin capturing video via the drone camera; and
receives, via the tether cable, video captured via the drone camera while the tethered vehicular drone is deployed at the tethered flight position.

20. The vehicular computing device of claim 19, wherein the vehicular power source supplies operating power to the tethered vehicular drone via the tether cable.
